(19) United States
(12) Patent Application Publication
(10) Pub. No.: US 2009/0140716 A1
(43) Pub. Date: Jun. 4, 2009

(54) Circuit arrangement for generating a pulse width modulated signal for driving electrical loads

(76) Inventor: Luca Mantovani, Montevarchi (Arezzo) (IT)

Correspondence Address: COLLARD & ROE, P.C., 1077 NORTHERN BOULEVARD, ROSLYN, NY, 11576, US

(21) Appl. No.: 12/315,477

(22) Filed: Dec. 3, 2008

(30) Foreign Application Priority Data
Dec. 3, 2007 (EP) 07425769.2

(51) Int. Cl. H02M 3/156

(52) U.S. Cl. 323/351

(57) ABSTRACT

What is described is a circuit arrangement for the pulse width modulated drive of a load connected to a voltage supply line, including:
a voltage control/switch device interposed between the supply line and the load, and adapted to be controlled as to their conduction according to a predetermined duty cycle;
a capacitive filter, placed downstream of the said voltage control/switch means, in parallel with the load, and
a controlled current sink, connected to the capacitive filter, and adapted to operate as a sink of the current created by the discharge of the energy stored by the capacitive filter, which is switched to an activated state when the voltage control/switch device is non-conducting and is switched to an inactive state when the voltage control/switch device is conducting.

### CROSS REFERENCE TO RELATED APPLICATIONS

Applicant claims priority under 35 U.S.C. §119 of European Application No. 07425769.2 filed on Dec. 3, 2007.

### DESCRIPTION

1. Field of the Invention

The present invention generally relates to the supply and control of light sources, particularly light sources belonging to lighting systems for avionic applications, and more specifically to a circuit arrangement for the pulse width modulated drive of a light source.

2. Background of the Invention

LEDs are increasingly being used to replace incandescent lamps as light sources in instrument panel lighting in aircraft cockpits.

In order to achieve the large dynamic range of luminosity required, it is necessary to develop an electrical control circuit solution which is different from the conventional one associated with incandescent lamps, represented by a simple voltage supply. The standard solution is to drive the load (an LED light source) by means of a pulse width modulated (PWM) signal, and is characterized by the property of combining in a single drive signal the supply of energy to the source and the control of its luminosity (intensity and spectrum) by the variation of the electrical parameters of driving voltage (or current) and duty cycle.

The driving signal (power supply and control) is generated by a voltage drive circuit which in fact implements a power conversion from a continuous supply signal to a modulated pulse width signal, and must meet predetermined requirements of security (short circuit protection), simplicity (smaller number of components and smaller circuit size), reliability, and compliance with electromagnetic compatibility regulations.

A PWM drive circuit specifically designed to drive LEDs in avionic applications must also meet other requirements, such as a large dynamic range of luminosity (the ratio between maximum and minimum luminosity) of about 4000 or even more, the possibility of controlling luminosity in accordance with the different lighting functions required, and the capacity for driving a non-linear load (for a drive voltage below a threshold, an LED is extinguished) and a variable load (with a current demand from a few mA to 1-3 A) in accordance with the number of light sources to be switched on.

In order to achieve the large dynamic range required, it is necessary to adjust the amplitude of the control signal and simultaneously to modulate its pulse width.

Furthermore, the drive circuit must be adapted to receive a variable supply voltage, in accordance with the various regulations governing the intended application (DO-160E, MIL-STD-704, etc.).

In detail, equipment designed to provide a PWM voltage supply line for avionic applications is normally supplied from the external power supply line. This line may be subject to variations of the working voltage, high-energy spurious pulses and anomalous transients (for example, voltages of 80 V may be reached for 100 ms on nominal 28 V direct current lines).

The simplest circuit solution is the use of a switching device which is opened and closed according to a control square wave (FIG. 1). In this case, the number of components, the overall dimensions and the weight are reduced to the smallest possible levels.

However, the generation of the PWM signal causes many problems in terms of electromagnetic energy emission in a wide frequency range between the fundamental and 1 GHz.

In order to keep these emissions below the limits permitted by the regulations, it is possible to use screened cables or twisted connections (with the PWM signal output cable twisted with the corresponding return line).

The alternative, in the case of single connections, is to control the slope of the signal edges; in other words the output voltage waveform must be at least trapezoidal (with constant-slope edges) and not a square wave (although this would be ideal).

In order to obtain these inclined edges, a linear voltage control and switching stage must be used in place of the simple switching device which is opened and closed (ON/OFF). This also has the advantage that, since the output voltage can be controlled, the load is protected from transients on the power supply line.

The simplest method of constructing a circuit of this type is to connect a MOSFET transistor in series with the power supply line, and to drive it so that it is alternately conducting and non-conducting according to a predetermined duty cycle (FIG. 2). In this case, the control voltage waveform is reproduced at the output with a predetermined amplification. In general, this solution provides efficient control of the drive signal, and control of the slope of the leading edge of the voltage pulses. However, the simple topology does not enable energy to be drained from the load in the period in which the transistor is non-conducting, and therefore the second part of the drive signal waveform is dependent on the load.

The conventional approach to the resolution of this problem is the use of push-pull stages, but these require negative power supplies and dedicated control circuits. In applications in which aspects such as size and weight are of fundamental importance, the aforementioned solution may be difficult to implement.

The electromagnetic compatibility requirements, imposed to limit the emissions caused by the generation of the PWM signal, make it necessary to provide powerful filtration of the PWM drive circuit output signal, requiring a capacitor on the output line (FIG. 3), and this degrades the performance of the output stage of the circuit in terms of stability and response to variations of load. The trailing edge of the voltage pulse is in fact strictly dependent on the load. With high output currents there are no problems, since the load discharges the energy stored in the capacitive filter and the trapezoidal waveform is practically ideal. With small output currents, the filter is not fully discharged, and the waveform is distorted as a result.

The phenomenon is illustrated in FIGS. 3 and 4. In the interval t0-t1, no current flows through the linear switch LS and the output voltage Vout is zero. In the interval t1-t2, a current I_{LS} is used to supply the load (with its portion I) and to charge the capacitor (with its portion I_{C} in the sub-interval t1-t1′). In the interval t2-t3, the capacitor is discharged by the load, and there is no control of the output by the linear switch, since the latter can only supply current to the load. The output voltage form is closely correlated with the time constant RC, which is a function of the resistance of the load and the capacitance of the filter capacitor. If RC<<(t3−t2), the output voltage follows the control; otherwise a distortion appears. If (t3−t2)<<RC<<(t4−t2), the output voltage is represented by the waveform of FIG. 5a; if RC>>(t4−t2), the output voltage is represented by the waveform of FIG. 5b; in other words, the PWM waveform is completely lost.

The resulting distortion increases the luminosity of the driven source in an undesired way, since the duty cycle is greater. Control of luminosity is therefore lost.

If the load were fixed in advance, the output current could conveniently be predetermined. However, in many applications, including avionic applications, the load is variable. This is because the value of the load is a function of the number of indicator lamps illuminated at one time, and this number is variable since the lamps can be switched off or on independently. The resistance of the load can generally vary from infinite (open circuit) to a minimum value of about 10 ohms.

An even greater disadvantage is that the energy stored in the filter prevents the efficient control of the duty cycle with small loads, since the output voltage does not decrease to zero as rapidly as would be required. The fact that the duty cycle information is strictly dependent on the load constitutes a problem when the PWM signal is used to supply a set of on-board alarm indicators (announcers).

The number of indicators switched on varies as a function of the condition of the on-board systems; in other words the total load is variable and depends on the number of announcers activated.

### SUMMARY OF THE INVENTION

The object of the present invention is therefore to provide a satisfactory solution to the problems described above, while avoiding the disadvantages of the prior art. In particular, the object of the present invention is to provide a circuit arrangement (topology) for the pulse width modulated drive of a light source which meets the requirements of simplicity and reliability, within the design constraints typical of avionic applications, while optimizing the circuit behaviour in terms of electrical and operational performance.

According to the present invention, these objects are achieved by means of a circuit arrangement having the characteristics claimed in Claim 1.

To summarize, the present invention is based on the principle of adding a current mode control to the conventional voltage mode control, to optimize the waveform of the PWM output signal in all conditions of load, environmental constraints and performance.

Current mode control is achieved by adding a circuit stage to the output line, including a controlled current generator as a current sink applied to the output and adapted to permit the control of the slope of the trailing edges of the pulses of the pulse width modulated drive signal, with intrinsic short circuit protection.

The output capacitor added to overcome problems of electromagnetic compatibility prevents the conventional circuit (FIGS. 1 and 2) from handling variable loads. With the proposed solution, this capacitor is used to produce a low-emission waveform.

When the linear switch is non-conducting, the controlled current sink is switched to an activated state and therefore discharges the energy stored in the filter. A constant current discharge produces a linear slope of the output voltage signal, creating an ideal trailing edge waveform for reducing electromagnetic emissions.

When the linear switch is conducting, the controlled current sink is switched to an inactive state in order to prevent losses of power at this stage.

### BRIEF DESCRIPTION OF THE DRAWINGS

Further characteristics and advantages of the invention will be disclosed more fully in the following detailed description of one embodiment of the invention, provided by way of non-limiting example, with reference to the attached drawings, in which:

FIGS. 1, 2 and 3 are schematic illustrations of circuit arrangement for the pulse width modulated drive of a load according to the prior art, with an insert showing the waveform of the output drive signal;

FIGS. 4, 5a and 5b are timing diagrams showing the variation of the pulse width modulated signal at the output of an ideal circuit arrangement and a real circuit arrangement respectively, according to the prior art of FIG. 3;

FIG. 6 is a schematic illustration of a circuit arrangement for the pulse width modulated drive of a load according to the invention;

FIGS. 7a-7c are detailed circuit diagrams illustrating different embodiments of a controlled current sink used in the circuit arrangement of FIG. 6;

FIG. 8 shows a set of diagrams illustrating the time variation of some electrical entities of the circuit arrangement of FIG. 6; and

FIGS. 9 and 10 are schematic illustrations of a circuit arrangement for the pulse width modulated drive of a load according to the invention, in two variant embodiments.

### DETAILED DESCRIPTION OF THE PREFERRED EMBODIMENTS

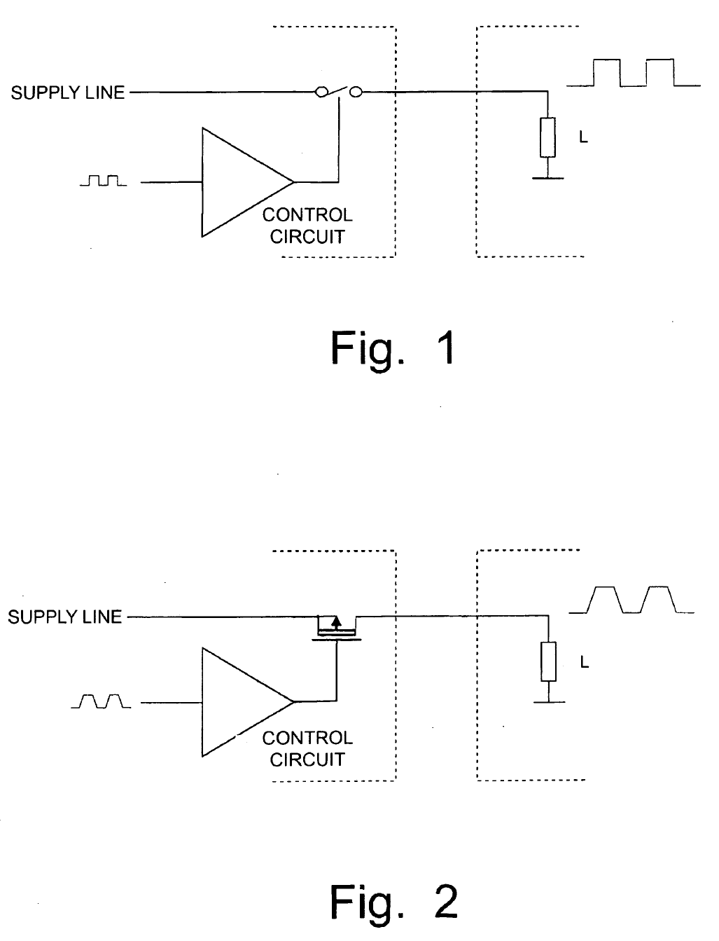

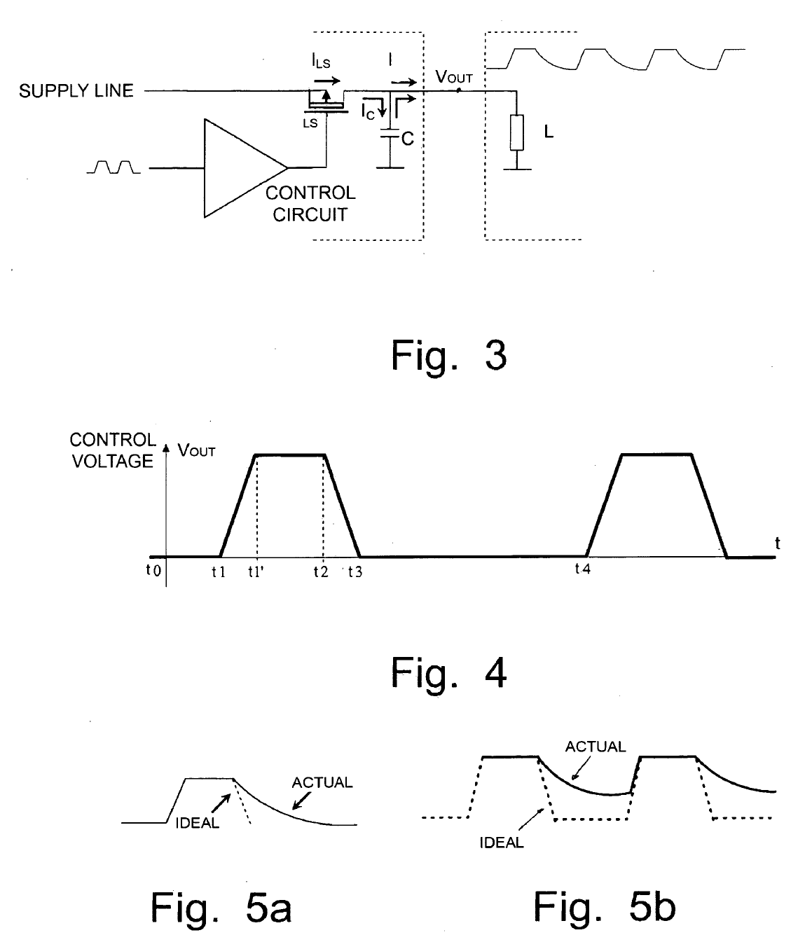

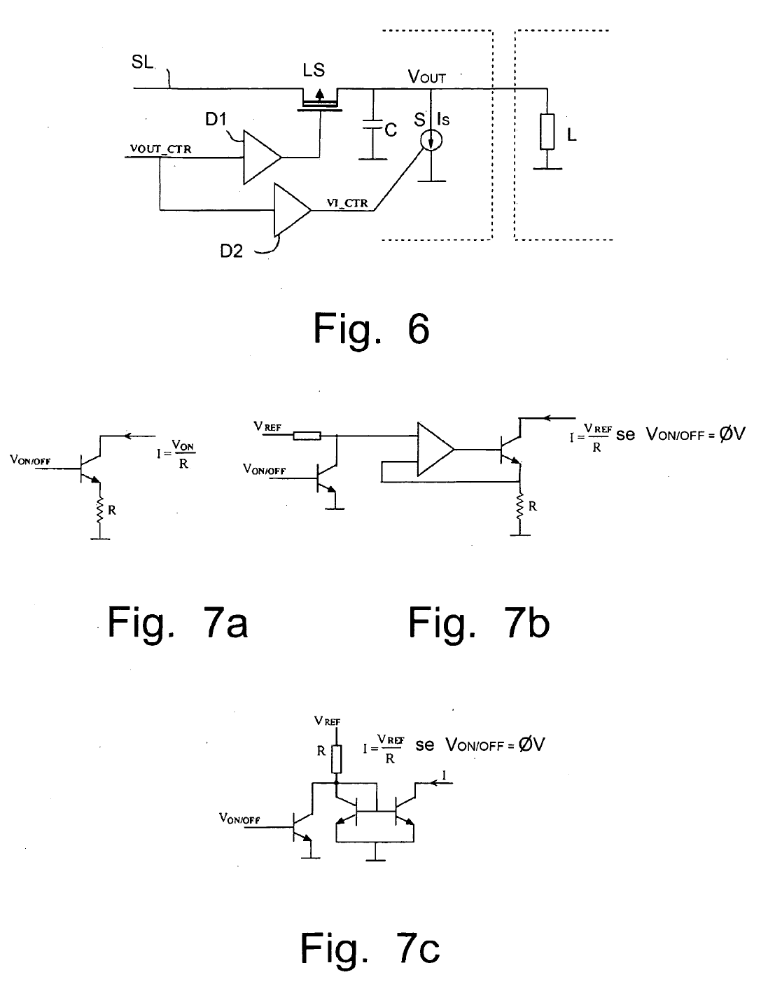

In FIGS. 6 to 10, elements or entities identical or functionally equivalent to those shown in FIGS. 1 to 5 are indicated by the same references used previously in the description of these preceding figures.

With reference to FIG. 6, a circuit arrangement for driving a load L (which may be resistive or non-linear), for example an LED lighting device for avionic applications, using a pulse width modulated voltage signal, is shown.

An external supply line SL is connected to the output of the driving arrangement through a voltage controlling linear switch device LS controlled by a voltage driver stage D1 which is adapted to receive a control signal VOUT_CTR from a control unit which is not shown.

A capacitive filter C is arranged downstream of the linear switch LS, in parallel with the load.

VOUT denotes the pulse width modulated voltage signal emitted from the output of the circuit arrangement proposed by the invention for driving (supplying and controlling) the load L.

The load, indicated as a whole by L, represents one or more distinct loads, each being a model of an LED light source, and is variable in time as a function of the number and temporary operating condition of the loads present.

S indicates a sink for a constant current I_{S}, controlled by a voltage driver stage D2 which is adapted to receive the control signal VOUT_CTR from the control unit and emit a drive signal VI_CTR according to a predetermined rule which is illustrated more fully in the remainder of the description.

FIGS. 7a-7c show, in the form of non-limiting examples, three different circuit embodiments of a current sink device, namely:
i) a current sink with a grounded transistor and a (emitter) feedback resistor, the controlled absorbed current being substantially equal to the ratio between the bias voltage of the transistor (indicated by V_{ON/OFF} and equal to the drive signal VI_CTR of FIG. 6) and the resistance of the feedback resistor;
ii) a current sink with feedback provided by an operational amplifier, in which the absorbed current is substantially equal to the ratio between the reference voltage VREF at one input of the operational amplifier and the resistance of the emitter resistor. The transistor controlled by V_{ON/OFF} is adapted to switch off the current sink; therefore the combination of V_{REF} and V_{ON/OFF} forms the voltage V_{I}_{_{—}}_{CTR} of FIG. 6;
iii) a current mirror topology, which is preferable for reducing the minimum possible output voltage. The current I is given by the ratio between the voltage V_{REF} and the resistance R. The voltage V_{ON/OFF} is adapted to switch the collector on and off through the base-driven transistor. The combination of V_{REF} and V_{ON/OFF} therefore forms the control voltage V_{I}_{_{—}}_{CTR} of FIG. 6.

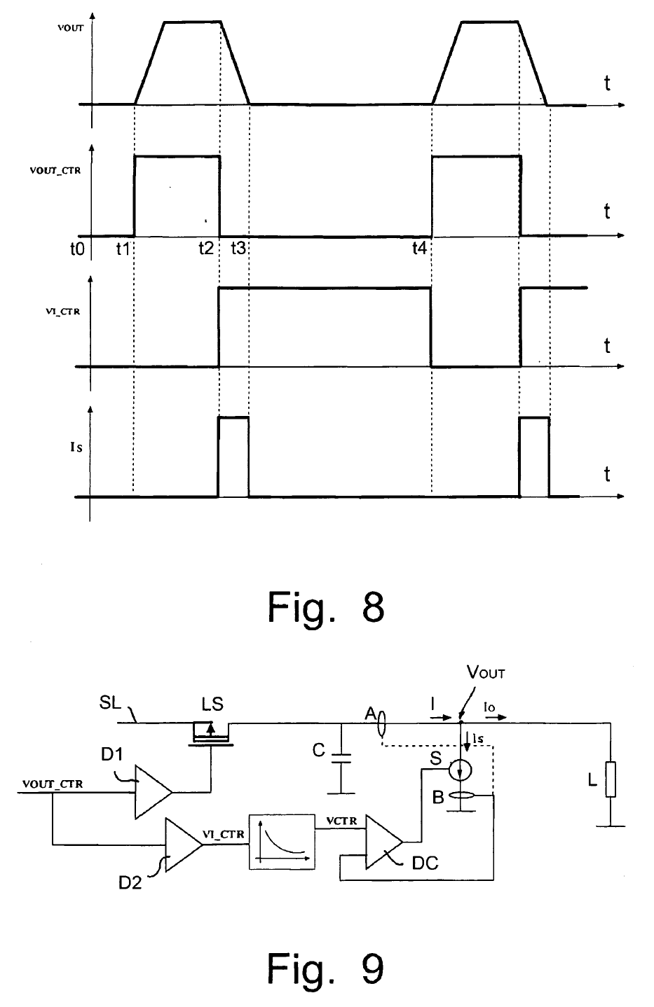

The operation of the circuit arrangement proposed by the invention will now be described with reference to FIG. 8.

The timing diagrams in the figure show, respectively, the variation in time of the output voltage VOUT of the circuit arrangement, of the control signal VOUT_CTR of the driver stages D1 and D2, of the current sink driving signal VI_CTR, and of the current I_{S}.

In the interval t1-t2, the output is controlled by means of the linear switch (MOSFET) LS and the corresponding driving circuit.

In the interval t2-t4, the linear switch is non-conducting (open) and no energy is supplied from the input supply line SL. The constant current sink is switched off in the interval t0-t2 and is switched on at t2. Up to the instant t3, the capacitive filter C is charged and the current sink discharges it by drawing current from it.

According to the theoretical equation for a capacitor (dV/dt=I/C), if the discharge current is constant (being determined by I_{S} in the present case), the slope of the voltage signal is ideally linear.

When the capacitor is discharged (t3-t4), no current flows in the sink, since the load is passive and the MOSFET linear switch LS is open.

This solution offers the following benefits:
the current sink is very simple to control, since a signal VI_CTR carrying only the ON/OFF information is sufficient;
no negative supply voltage source is needed to drive the current sink;
the control of the slope of the driving voltage signal is ideal, being intrinsic to the behaviour of the circuit;
the value of the slope is correlated with the internal components of the PWM generator; the capacitor C and the current I_{S}, and is independent of the load;
there is intrinsic short-circuit protection on the output.

The current sink driving signal can be defined to optimize different parameters, but in all cases the current sink is active only when the linear switch is open. In order to optimize the efficiency of the circuit, the current sink is preferably switched to its activated state in the interval t2-t3 only. This is helpful for protecting the circuit from short circuits on the output with respect to the power supply line. In this case, the protection is intrinsic, since the drained current is defined by the current I_{S}, and the power loss is reduced to a minimum, since the activation time is reduced.

In order to obtain a very low voltage, in other words a low impedance with respect to ground, when the voltage control switch LS is non-conducting, the current sink must be activated throughout the interval t2-t4 too, as shown in the figure.

Since a strong filter component is added to the input and output lines of the arrangement because of the requirements of susceptibility and electromagnetic emission containment, the dominant capacitive component is internal to the arrangement, and this ensures that the pulse edge decay time is independent of the value of the load, but is a function of the internal circuit parameters.

Other parameters, including the control voltage, can be optimized. By introducing a dedicated circuit stage, as shown schematically in FIG. 9, the output current I can be defined so as to control specific parameters.

The control signal VCTR reproduces the variation of the slope by means of a current feedback control mechanism which makes use of a differential circuit DC.

The current I in series with the output line can be read at the node A. In the discharge phase, the current is due solely to the capacitor, since the series controller/switch LS is non-conducting. In this condition the following relation is true:

$$\frac{d Vout}{d t} = - \frac{I}{C} = - \frac{k \cdot VCTR}{C}$$

assuming that Is >>Io.

However, if the current is read at node B (in other words, if Is is read), the derivative of the output voltage is:

$$\frac{d Vout}{d t} = - \frac{Is + Io}{C} = \frac{k \cdot VCTR}{C} - \frac{Io}{C}$$

and, if kVCTR>>Io, the previous relation is obtained.

The formulae show that the slope of the output voltage signal Vₒᵤₜ can be controlled by means of the current Iₛ absorbed by the sink, which is controlled by means of the voltage VCTR.

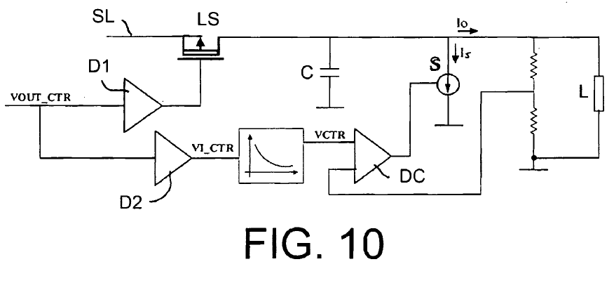

FIGS. 9 and 10 show an example of hyperbolic control voltage which enables the following type of output voltage to be obtained:

$$\frac{d Vout}{d t} ( t ) = - \frac{k}{C \cdot t} {\to }^{1 > {t}_{0}} {V}_{out} ( t ) = V max - \frac{k}{C} ln ( \frac{t}{{t}_{0}} )$$

where Vmax is the initial voltage and the peak amplitude of the waveform.

In general, however, the simplest application uses a constant VCTR, giving:

$$\frac{d Vout}{d t} ( t ) = - \frac{k}{C} ⇒ {V}_{out} ( t ) = V max - \frac{k}{C} \cdot t$$

making it possible to obtain a trailing edge of the trapezoid whose derivative is constant.

According to the circuit of FIG. 10, it is possible to feedback directly the output voltage (or part of it) by using the differential circuit DC. In this case, the control voltage VCTR must have the desired variation of the output voltage when the latter is required to decrease. The differential circuit DC directly drives the current sink, which discharges the capacitor C and thus provides the desired variation of the output voltage.

Clearly, provided that the principle of the invention is retained, the forms of application and the details of construction can be varied widely from what has been described and illustrated purely by way of non-limiting example, without departure from the scope of protection of the present invention as defined by the attached claims.

What is claimed is:

1. Circuit arrangement for the pulse width modulated drive of a load connected to a voltage supply line, including:
voltage control/switch means interposed between the said supply line and the load, and adapted to be controlled in a conduction state according to a predetermined duty cycle; and
capacitive filter means, placed downstream of the said voltage control/switch means, in parallel with the load,
comprising controlled current sink means, connected to the said capacitive filter means, and adapted to operate as a sink of a current provided by the discharge of the energy stored by the said capacitive filter means,
the said current sink means being adapted to be switched to an activated state when the said voltage control/switch means are non-conducting, and to an inactive state when the said voltage control/switch means are conducting.

2. Arrangement according to claim 1, in which the said current sink means are adapted to be switched to an activated state when the said voltage control/switch means are non-conducting and the said capacitive filter means have stored a non-zero charge.

3. Arrangement according to claim 1, in which the said controlled current sink means include a constant current sink circuit driven by a voltage signal.

4. Arrangement according to claim 3, in which the said driving voltage signal is emitted by a driving circuit of the current sink means controlled by a control unit arranged to control a driving circuit of the duty cycle of the said voltage control/switch means.

5. Arrangement according to claim 3, in which the said current sink means comprise a bipolar junction transistor, having its emitter terminal connected to a reference potential through a feedback resistor and switched to the conducting or non-conducting state as a function of a bias voltage applied to the base terminal, the constant current being substantially equal to the ratio between the bias voltage and the resistance of the feedback resistor.

6. Arrangement according to claim 3, in which the said current sink means comprise a bipolar junction transistor which is switched to a conducting or non-conducting state as a function of the voltage applied to the base terminal, and which is connected by its emitter terminal to a reference potential through a feedback resistor, in which the voltage applied to the base terminal is established at the output of an operational amplifier circuit having a first input on which a driving voltage signal is established, and a second input to which the voltage established at the said emitter terminal is fed back, the constant current being substantially equal to the ratio between the driving voltage and the resistance of the emitter resistor.

7. Arrangement according to claim 3, in which the said current sink means comprise a current mirror circuit.

8. Arrangement according to claim 3, in which the driving voltage signal for the current sink means is emitted by a driving circuit in differential amplifier configuration, which receives at its input a first voltage signal from the said control unit and is adapted to perform a feedback control with reference to a predetermined current.

9. Arrangement according to claim 3, in which the driving voltage signal for the current sink means is emitted by a driving circuit in differential amplifier configuration, which receives at its input a first voltage signal from the said control unit, and is adapted to perform a feedback control with reference to a predetermined voltage.

10. Arrangement according to claim 1, in which the said current sink means are connected across the terminals of the capacitive filter means and of the load.
